(19) United States
(12) Patent Application Publication
(10) Pub. No.: US 2012/0018611 A1
(43) Pub. Date: Jan. 26, 2012

(54) VIBRATION ISOLATION TARGET MOUNTING STRUCTURE AND METHOD

(75) Inventors: Itaru Ishii, Okazaki-city (JP); Tameharu Ohta, Takahama-city (JP); Takeshi Shinoda, Nagoya-city (JP); Keisuke Nakano, Nishio-city (JP)

(73) Assignee: DENSO CORPORATION, Kariya-city (JP)

(21) Appl. No.: 13/186,506

(22) Filed: Jul. 20, 2011

(30) Foreign Application Priority Data
Jul. 23, 2010 (JP) 2010-166036

(51) Int. Cl. F16F 15/02; B29C 65/54

(52) U.S. Cl. 248/636; 156/307.7

(57) ABSTRACT

A bonding structure of a vibration isolation target is disclosed. The structure includes: a base; a vibration isolation target mounted to the base; and a vibration isolator bonds together the base and the vibration isolation target. A lift-up portion is formed on one of the base and the vibration isolation target, and is lift-upped from the one toward the other of the base and the vibration isolation target. The lift-up portion has an apex surface located at an apex of the lift-up portion. The vibration isolator is on the apex surface.

### CROSS REFERENCE TO RELATED APPLICATION

The present application is based on and claims priority to Japanese Patent Application No. 2010-166036 filed on Jul. 23, 2010, disclosure of which is incorporated herein by reference.

### TECHNICAL FIELD

The present invention relates to a structure and a method for bonding a vibration isolation target to a base via a vibration isolator.

### BACKGROUND

A known structure for bonding a vibration isolation target to a base via a vibration isolator is shown in, for example, Patent Document 1. In the structure, the vibration isolation target, which includes an oscillator etc. and is averse to an external vibration, is bonded to a base via a vibration isolator for damping a relative vibration between the base and the vibration isolation target.

In Patent Document 1 (see FIG. 6), a sensor apparatus (e.g., angular velocity sensor) is configured such that a sensor element for angular velocity detection is mounted to a mounting board, and the mounting board is received in a case having a case body and a cover. The mounting board is connected to an upper surface of a rectangular plate shaped cover via an adhesive having an elastic property (vibration absorption property).

In the above, if an external vibration is conducted to the cover, the external vibration is absorbed at the adhesive. Thus, conduction of the vibration to the mounting board can be suppressed, and as a result, a negative influence of the vibration on detection performance of the sensor element can be suppressed.
Patent Document 1: JP-2008-224428A

A vibration isolator like the above-described adhesive has a function to bond a vibration isolation target to a base. With use of the vibration isolator, a vibration isolation target may be mounted to a base in the following way. A vibration isolator in a liquid form or in a semi-cured state (i.e., what is called a B stage state) is placed on one of the base and the vibration isolation target. Then, for example, the other, on which the vibration isolator is not placed, of the base and the vibration isolation target is positioned and placed so as to contact the vibration isolator. Then, the vibration isolator is cured by, for example, heat.

In Patent Document 1, a contact surface between the vibration isolation target (e.g., the mounting board having the sensor element) with the vibrator isolator (e.g., the adhesive), and a contact surface of the cover (acting as the base) with the vibration isolator (the adhesive) are flat surfaces and are quite large as compared with a region where the vibration isolator is applied. Therefore, when the vibration isolator in the liquid form is used, the vibration isolator spreads by wetting on the flat surface until the vibration isolator has a certain contact angle θ₁ according to the surface tension. This wetting and spreading occur at a time of applying the vibration isolator, and at a time of positioning and placing the base and the vibration isolation target after applying the vibration isolator.

Thus, as an application quantity or a distance between the base and the vibration isolation target varies, the shape of the vibration isolator after the curing varies. Specifically, a contact area between the vibration isolation target and the vibration isolator and a contact area between the base and the vibration isolator can vary. Since frequencies of the vibration suppressible by the vibration isolator (associated with a structure-related resonance of vibration isolator) can vary depending on the contact area, the frequencies of the vibration suppressible by the vibration isolator can vary as the contact area varies. Therefore, the vibration of a predetermined frequency, which has a negative influence on the vibration isolation target, may not be efficiently reduced at the vibration isolator. As for the vibration isolator in the semi-cure state, the vibration isolator becomes a liquid form when being cured, and wets and spreads on the flat surface until the vibration isolator has the certain contact angle θ₁.

### SUMMARY

In view of the foregoing, it is an objective of the present disclosure to provide a vibration isolation target bonding structure that is capable of suppressing vibration of a predetermined frequency. It is an also an objective of the present disclosure to provide a method for forming a vibration isolation target bonding structure.

According to an aspect of the present disclosure, a bonding structure includes: a base; a vibration isolation target that is mounted to the base and is a target for vibration isolation; and a vibration isolator that is arranged between and bonds together the base and the vibration isolation target, and damps a relative vibration between the base and the vibration isolation target. The base and the vibration isolation target have, respectively, a first opposed surface and a second opposed surface opposed to each other. A lift-up portion is formed on at least one of the first opposed surface and the second opposed surface, and is lift-upped from the one toward the other of the first opposed surface and the second opposed surface. The lift-up portion has: an apex surface located at an apex of the lift-up portion, a side surface surrounding the apex surface; and a corner formed by the apex surface and the side surface so that the corner surrounds the apex surface. The vibration isolator bonds only the apex surface, out of one of the first opposed surface and the second opposed surface, to the other of the first opposed surface and the second opposed surface.

According to another aspect of the present disclosure, a method for forming the above bonding structure is provided. The method includes: placing the vibration isolator in a liquid form or the vibration isolator in a semi-cured state on one of the base and the vibration isolation target so that the vibration isolator is placed on the apex surface of the lift-up portion or a opposed portion that is opposed to the apex surface; positioning and placing the other of the base and the vibration isolation target with respect to the one, on which the vibration isolator is placed, of the base and the vibration isolation target, so that the apex surface of the lift-up portion or the opposed portion is in contact with the vibration isolator; and curing the vibration isolator after positioning and placing the other of the base and the vibration isolation target.

According to the above structure and method, it is possible to suppress vibration of a predetermined frequency at the vibration isolator.

### BRIEF DESCRIPTION OF THE DRAWINGS

The above and other objects, features and advantages of the present invention will become more apparent from the following detailed description made with reference to the accompanying drawings. In the drawings:

FIG. 1 is a cross sectional view illustrating a bonding structure of a vibration isolation target in accordance with a first embodiment;

FIG. 2 is an enlarged cross sectional view of a lift-up portion of FIG. 1;

FIG. 3 is a plan view of a base viewed from a lift-up portion side;

FIG. 4A is a cross sectional view illustrating a vibration isolator placing step of a bonding method of a vibration isolation target;

FIG. 4B is a cross sectional view illustrating a positioning placing step of the bonding method of a vibration isolation target;

FIG. 5 is a diagram for explanation of an effect of a lift-up portion;

FIGS. 6A and 6B are plan views for explanation of an effect of shape of an apex surface;

FIG. 7A is a cross sectional view illustrating a vibration isolator placing step of a bonding method of a vibration isolation target in accordance with a modification example;

FIG. 7B is a cross sectional view illustrating a positioning placing step of the bonding method of a vibration isolation target in accordance with the modification example;

FIG. 8 is a cross sectional view illustrating a bonding structure of a vibration isolation target in accordance with another modification example;

FIG. 9A is a cross sectional view illustrating a vibration isolator placing step of a bonding method of a vibration isolation target in accordance with a second embodiment;

FIG. 9B is a cross sectional view illustrating a positioning placing of the bonding method of a vibration isolation target in accordance with the second embodiment;

FIG. 10 is a cross sectional view illustrating a bonding structure of a vibration isolation target in accordance with a third embodiment;

FIG. 11 is a plane view illustrating a base viewed from a lift-up portion side in accordance with the third embodiment;

FIG. 12 is a cross sectional view illustrating a schematic configuration of a sensor apparatus in accordance with a fourth embodiment;

FIG. 13 is a cross sectional view illustrating a schematic configuration of a sensor unit acting as a vibration isolation target;

FIG. 14 is a plan view illustrating a schematic configuration of a sensor chip of a vibration isolation target;

FIG. 15 is a plan view illustrating a schematic configuration of a case acting as a base;

FIG. 16 is a cross sectional view taking along line XVI-XVI in FIG. 15;

FIG. 17 is a cross sectional view illustrating a schematic configuration of a sensor apparatus in accordance with a fifth embodiment;

FIG. 18 is a cross sectional view illustrating a schematic configuration of a sensor unit acting as a vibration isolation target in accordance with the fifth embodiment;

FIG. 19 is a plan view illustrating a case acting as a base in accordance with the fifth embodiment;

FIG. 20 is a cross sectional view illustrating a schematic configuration of a sensor apparatus in accordance with a sixth embodiment; and

FIG. 21 is a cross sectional view illustrating another modification.

### EMBODIMENTS

Embodiments will be described with reference to the accompanying drawings. In the below-described embodiments, like reference numerals are used to refer to like parts.

### First Embodiment

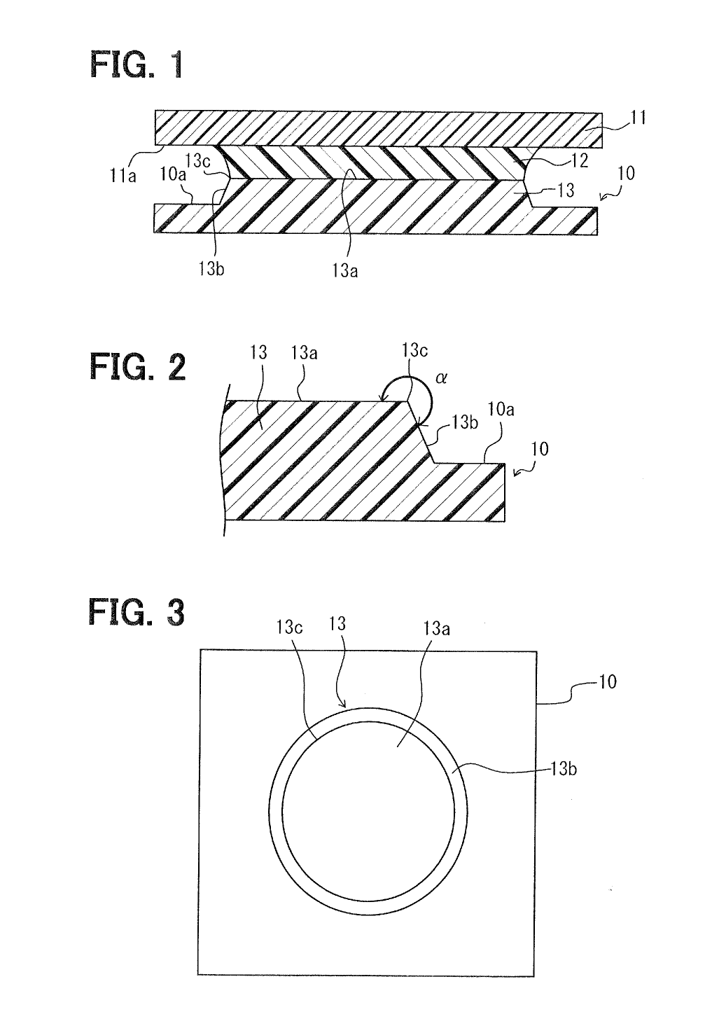

A bonding structure of a vibration isolation target according to the present embodiment is illustrated in FIG. 1. A base 10 and a vibration isolation target 11 are bonded to each other by a vibration isolator 12 arranged between the base 10 and the vibration isolation target 11, thereby constituting a single unit (e.g., an electronic apparatus).

The base 10 is a member for fixing or supporting the vibration isolation target 11. For example, the base 10 may be a circuit board to which the vibration isolation target 11 is mounted, a case which protects the vibration isolation target 11, a fixing member which fixes the vibration isolation target 11 to a predetermined part, or the like.

A lift-up portion 13 is arranged on one surface 10a of the base 10, as shown in FIGS. 1 to 3. The one surface 10a is opposed to the vibration isolation target 11. The number of lift-up portions 13 arranged on the one surface 10a is not limited to a particular number. For illustrative purpose, one lift-up portion 13 is illustrated in the present embodiment.

The lift-up portion 13 is lift-upped from the one surface 10a of the base 10 toward the vibration isolation target 11. The lift-up portion 13 has an apex surface 13a that is planner and true circular. The apex surface 13a is in contact with the vibration isolator 12. As shown in FIG. 2, the lift-up portion 13 further has a side surface 13b connected to the apex surface 13a. The apex surface 13a and the side surface 13b have an angle α therebetween, which is a predetermined constant angle larger than 180 degrees. Thereby, the apex surface 13a and the side surface 13b form therebetween a corner, which surrounds the apex surface 13a.

As long as the angle α between the apex surface 13a and the side surface 13b is a constant angle larger than 180 degrees and smaller than 360 degrees, the angle α is not limited to a particular angle. For example, the adopted angle α may be 230 degrees, 270 degrees, 300 degrees or the like. In order to make the corner to suppress wetting and spreading of the vibration isolator 12, it may be preferable that the angle α be away from 180 degrees as far as possible. Furthermore, in order to integrally form the lift-up portion 13 and the base 10 (or the vibration isolation target 11) using a mold, it may be preferable to set the angle α smaller than 270 degrees in consideration of taking out a molded body from the mold. To meet the above, the angle α may be set, for example, greater than or equal to 200 degrees and less than or equal to 250 degrees. If the lift-up portion 13 is made by processing after integral molding or by bonding and fixing another part, it is possible to improve flexibility in setting the angle α between the apex surface 13a and the side surface 13b.

The vibration isolation target 11 is averse to an external vibration, e.g., an external vibration causing a detection error. The vibration isolation target 11 may include, for example, an oscillator which oscillates when driven, a movable portion which displaces according to physical quantity, or the like.

As shown in FIG. 1, the lift-up portion 13 is not arranged on one surface 11a, which is opposed to the base 10, of the vibration isolation target 11. A portion of the one surface 11a is a flat surface with which the vibration isolator 12 is in contact. The vibration isolator 12 is in contact with both of the base 10 and the vibration isolation target 11, thereby bonding the base 10 and the vibration isolation target 11 to each other. The vibration isolator 12 damps a relative vibration between the base 10 and the vibration isolation target 11. The vibration isolator 12 is made of a curable material.

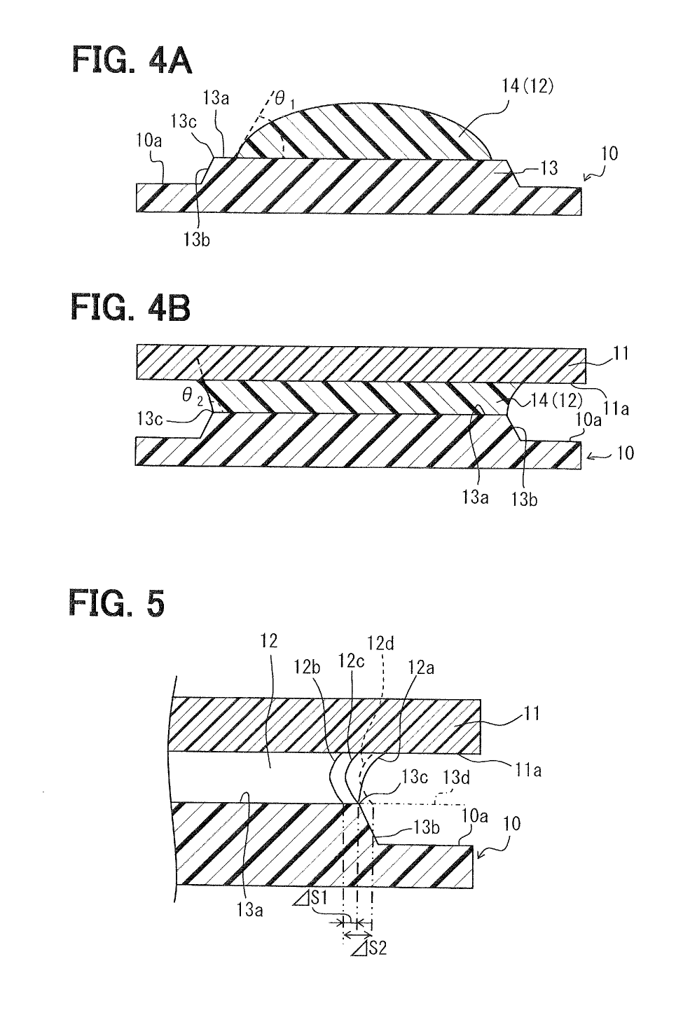

An elastomer that is in a liquid form at a time of placing (i.e., applying) is employed for the vibration isolator 12. Because of this vibration isolator 12, even when the external vibration is applied to the base 10, it is possible to damp the vibration before the vibration is conducted to the vibration isolation target 11. The vibration isolator 12 spreads to an outer perimeter 13c of the apex surface 13a of the lift-up portion 13 and is in contact with the whole apex surface 13a. A contact angle of the vibration isolator 12 with respect to the apex surface 13a of the lift-up portion 13 of the base 10 is θ₂, which is larger than the predetermined contact angle θ₁ according to the surface tension and will be described later (see FIGS. 4A, 4B).

Next, one example of a method for forming the above described bonding structure of the vibration isolation target will be described. The method may be also called a method for bonding a vibration isolation target, or a manufacturing method of the above-described unit.

As shown in FIG. 4A, using a dispenser or the like, a vibration isolator 14 in the liquid form, which will be changed into the vibration isolator 12 after being cured, is placed on (i.e., applied to) a portion of the apex surface 13a (e.g., the vicinity of the center of the apex surface 13a) of the lift-up portion 13 provided on the base 10. The applied vibration isolator 14 wets and spreads on the apex surface 13a until the vibration isolator 14 has the predetermined contact angle (θ₁), which is based on the surface tension known from Young's equation.

In the present embodiment, the vibration isolation target 11 is pushed against the vibration isolator 14 in the below-described step of positioning and placing the vibration isolation target 11. Thus, an application quantity of the vibration isolator 14 (12) in the step of placing the vibration isolator 14 is set in consideration of the spread of the vibration isolator 14 due to the pushing. The application quantity of the vibration isolator 14 is set so that at a time when the vibration isolator 14 has the predetermined contact angle θ₁, there is a space between the outer perimeter 13c of the apex surface 13a and an end of the vibration isolator 14. In other words, when the vibration isolator 14 has the predetermined contact angle θ₁, the vibration isolator 14 is in contact with only a portion of the apex surface 13a.

After the vibration isolator 14 is placed, the positioning and placing are performed in the following way. While the vibration isolation target 11 is being positioned so that the portion, which is to contact the vibration isolator 14(12), of the one surface 11a, contacts the vibration isolator 14, the one surface 11a is pushed against the vibration isolator 14, and the vibration isolation target 11 is placed on the base 10.

In the above, the vibration isolator 14 in the liquid form receives pressure from the vibration isolation target 11, flows in directions along the apex surface 13a of the lift-up portion 13, and wets and spreads on the apex surface 13a toward the predetermined contact angle θ₁ based on the surface tension. However, in the present embodiment, before the vibration isolator 14 has the predetermined contact angle θ₁, the vibration isolator 14 reaches the outer perimeter 13c of the apex surface 13a. And the vibration isolator 14 does not immediately wet and spread into the side surface 13b but deforms so as to have a smaller radius of curvature with an end of the vibration isolator 14 being fixed to the outer perimeter 13c. As a result, as shown in FIG. 4B, the contact angle of the vibration isolator 14 becomes θ₂, which is larger than the predetermined contact angle θ₁ based on the surface tension.

Then, in the above state, the vibration isolator 14 is cured by, for example, heat. Through the above steps, the bonding structure of the vibration isolation target illustrated in FIG. 1 can be formed.

Next, there will be described advantages of the above-described bonding structure and bonding method of the vibration isolation target.

In the present embodiment, the lift-up portion 13 is arranged on the one surface 10a of the base 10 so that the side surface 13b is inclined with respect to the apex surface 13a, with which the vibration isolator 12 is to be in contact. That is, the apex surface 13a and the side surface 13b form therebetween a corner surrounding the apex surface 13a. The vibration isolator 14 can wet and spread when, for example, the vibration isolator 14 in the liquid form is cured to bond the vibration isolation target 11 to base 10. In this case, even when the vibration isolator 14 wets, spreads and reaches the outer perimeter 13c of the apex surface 13a before the contact angle becomes the predetermined contact angle θ₁, the vibration isolator 14 does not immediately wet and spread into the side surface 13b beyond the outer perimeter 13c. Instead, the vibration isolator 14 deforms so as to have a smaller radius of curvature with the end of the vibration isolator 14 being fixed to the outer perimeter 13c.

Therefore, even when the application amount of the vibration isolator 14 varies or the distance between the base 10 and the vibration isolation target 11 opposed to each other varies, the wetting and spreading of the vibration isolator 14 can be confined to the apex surface 13a. Therefore, it is possible to keep the vibration isolator 14 located inside the apex surface 13a of the lift-up portion 13.

For example, as the application amount of the vibration isolator 14 varies, the position of the end of the vibration isolator 12 may vary between a position 12a to a position 12b as shown in FIG. 5. In FIG. 5, the position 12a corresponds to a case of a maximum application amount and the contact angle of θ₂ with respect to the apex surface 13a. The position 12b corresponds to a case of a minimum application amount and the contact angle of θ₁ with respect to the apex surface 13a. In FIG. 5, a variation in contact area between the apex surface 13a of the lift-up portion 13 and the vibration isolator 12 is illustrated by ΔS1, which is actually annular although FIG. 5 illustrates a cross section of ΔS1. The reference numeral 12c, which refers to the end of the vibration isolator 12 in FIG. 5, shows a case where the end of the vibration isolator 12 reaches the outer perimeter 13c and the contact angle is θ₁.

Let us consider a comparison example in which the base 10 does not have the lift-up portion 13. A dotted-dashed line in FIG. 5 shows a hypothetical surface 13d that is continuously connected and parallel to the apex surface 13a. It is assumed that the variation of application amount of the vibration isolator 14 is the same between this comparison example and the present embodiment. In the comparison example, the vibration isolator 12 of the maximum application amount wets and spreads to a position 12d until the vibration isolator 14 has the predetermined contact angle θ₁ beyond the outer perimeter 13c. That is, a distance from the center of the apex surface 13a to the position 12d is larger than a distance from the center of the apex surface 13a to the outer perimeter 13c. Therefore, in the comparison example, the variation in contact surface between the apex surface 13a of the lift-up portion 13 and the vibration isolator 12 becomes ΔS2 and is larger than ΔS1. It should be noted that the variation ΔS2 is actually annular although the ΔS2 is a sectional view in FIG. 5.

As can be seen from the above, the present embodiment can reduce the variation in contact surface between the vibration isolator 12 and the base 10 having the lift-up portion 13. Therefore, the present embodiment can efficiently suppress the vibration of a specific frequency, e.g., the vibration of a frequency having a negative influence on the vibration isolation target 11.

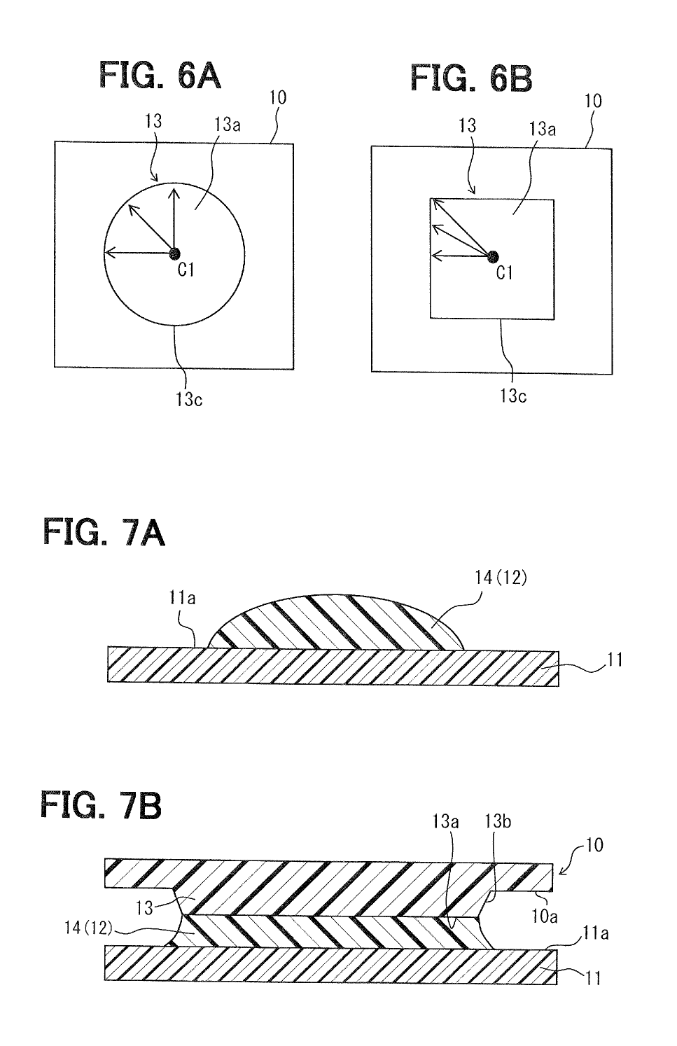

The shape of the apex surface 13a of the lift-up portion 13 is not limited to the true circular shape. For example, the apex surface 13a of the lift-up portion 13 may be polygonal. As shown in FIG. 6B, in the case of the polygonal apex surface 13a of the lift-up portion 13 (e.g., a rectangular shape as shown in FIG. 6B), the distance from the center C1 of the apex surface 13a to the outer perimeter 13c is not constant; as a result, the time when the vibration isolator 14 reaches the outer perimeter 13c is different from place by place. Therefore, the contact area may vary in a range from when the vibration isolator 14 reaches a certain portion of the outer perimeter 13c to until the vibration isolator 14 reaches the whole outer perimeter 13c.

By contrast, in the example shown in FIG. 6A, the shape of the apex surface 13a of the lift-up portion 13 is the true circular shape. Because of this, when the vibration isolator 14 in the liquid form is applied to the vicinity of the center C1 of the apex surface 13a as illustrated in FIG. 6A, the vibration isolator 14 wets and spreads in all directions and reaches the whole outer perimeter 13c at the substantially same time. Therefore, it is possible to efficiently suppress the variation in contact area between the vibration isolator 12 and the apex surface 13a.

It should be noted that the bonding method of the vibration isolation target 11 is not limited to the above-described bonding method. For example, the bonding method may be modified in the following way. As shown in FIG. 7A, the vibration isolator 14 in the liquid form is applied to one surface 11a of the vibration isolation target 11 that does not have the lift-up portion 13. Then, as shown in FIG. 7B, the applied vibration isolator 14 is brought into contact with the apex surface 13a of the lift-up portion 13. Thereby, the base 10 having the lift-up portion 13 is positioned relative to and placed on the vibration isolation target 11. However, when the vibration isolator 14 in the liquid form is applied to the apex surface 13a of the lift-up portion 13, even if the application amount varies, the wetting and spreading of the vibration isolator 12 can be confined to the apex surface 13a before the vibration isolation target 11 is positioned and placed. Therefore, it is possible to form the bonding structure of the vibration isolation target 11 more reliably.

In the above example configuration, the lift-up portion 13 is arranged on only the base 10 out of the base 10 and the vibration isolation target 11. Alternatively, the lift-up portion 13 may be arranged on the vibration isolation target 11. In this configuration, the same advantages are obtainable.

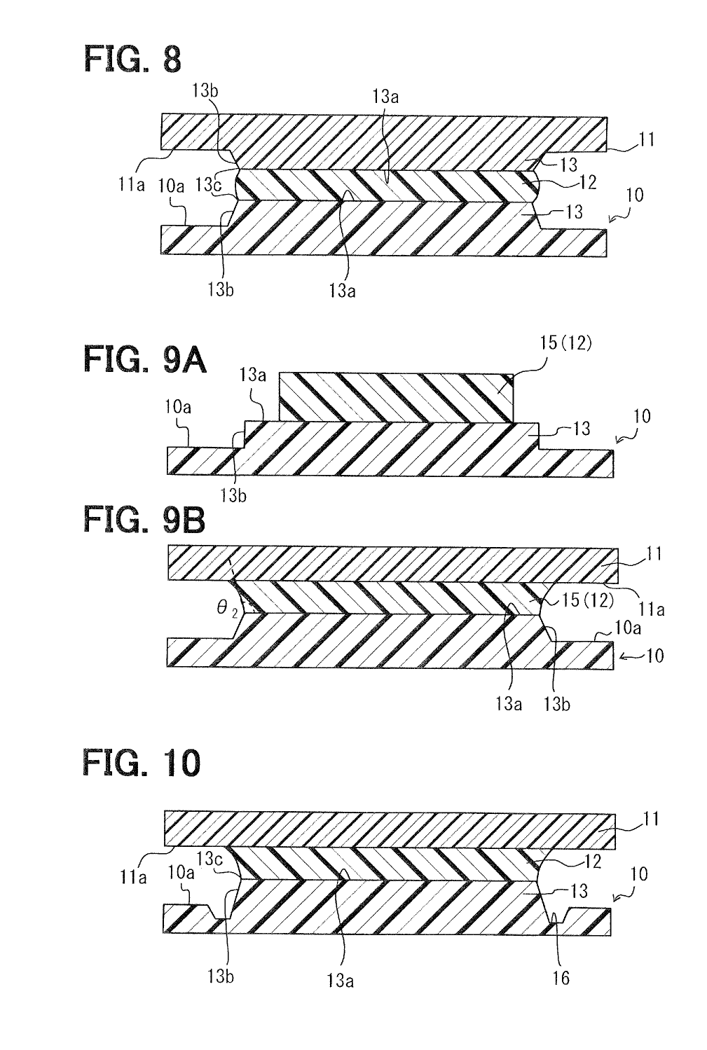

Alternatively, as shown in FIG. 8, the lift-up portion 13 may be formed as a first lift-up portion 13 and a second lift-up portion 13, which are arranged on both of the base 10 and the vibration isolation target 11, respectively. In this case, the apex surface 13a of the first lift-up portion 13 of the base 10 and the apex surface 13a of the second lift-up portion 13 of the vibration isolation target 11 are the same in shape and size, and are arranged opposed to each other. In other words, the first lift-up portion 13 is located so that an projection image of the first lift-up portion 13 of the base 10 on the vibration isolation target 11 created by irradiation of a light beam in a direction normal to the apex surface 13a overlaps with the second lift-up portion 13. In this configuration, it is possible to reduce both of the variation in contact surface between the vibration isolator 12 and the base 10 and the variation in contact surface between the vibration isolator 12 and the vibration isolation target 11.

In the above example, the vibration isolator 14 in the liquid form is cured by heat, and thereby formed into the vibration isolator 12. Alternatively, the vibration isolator 14 may be cured by not heat. For example, the vibration isolator 14 may be cured b light irradiation (e.g., ultraviolet irradiation) or the like.

### Second Embodiment

In the present embodiment, a vibration isolator 15 in a semi-cured state is used in place of the vibration isolator 14 in the liquid form.

As shown in FIG. 9A, the vibration isolator 15 in a semi-cured film form, which will be changed into the vibration isolator 12 after being cured, is placed on a portion (e.g., the vicinity of the center of the apex surface 13a) of the apex surface 13a of the lift-up portion 13 of the base 10. In the above, since the vibration isolator 15 is in the semi-cured state, the vibration isolator 15 does not spread by wetting and stays at a given place.

In the present embodiment, when the vibration isolator 15 is cured, the vibration isolation target 11 is pushed against the vibration isolator 15 and the vibration isolator 15 spreads. In consideration of the spread of the vibration isolator 15 by the pushing, the vibration isolator 15 is placed on the apex surface 13a so that a space exits between the outer perimeter 13c of the apex surface 13a and an end of the vibration isolator 15. In other words, the vibration isolator 15 is placed so to contact only the portion of the apex surface.

Then, the vibration isolation target 11 is placed on the vibration isolator 15 while being positioned with respect to the base 10, so that a portion, which is to contact the vibration isolator 15 (12), of the one surface 11a of the vibration isolation target 11 contacts the vibration isolator 15.

In the above positioning state, the vibration isolator 15 is heated while the vibration isolation target 11 is pressed toward the base 10. This heating changes the vibration isolator 15 in the semi-cured state into a liquid form before the vibration isolator 15 is cured. Then, the vibration isolator 15 in the liquid form receives pressure from the vibration isolation target 11, flows in directions along the apex surface 13a of the lift-up portion 13, and wets and spreads on the apex surface 13a toward the predetermined contact angle of θ₁ based on the surface tension. However, in the present embodiment, before the vibration isolator 15 has the predetermined contact angle θ₁ by wetting and spreading, the vibration isolator 15 reaches the outer perimeter 13c of the apex surface 13a. And the vibration isolator 15 does not immediately wets and spreads into the side surface 13b beyond the outer perimeter 13c but the vibration isolator 15 deforms so as to have smaller radius of curvature with the end of the vibration isolator 15 being fixed at the outer perimeter 13c.

In this deformed state, the vibration isolator 15 is cured, and the bonding structure of the vibration isolation target as illustrated in FIG. 1 is formed.

As can be seen from the above, the use of the vibration isolator 15 in the semi-cured state involves the substantially same advantages as the use of the vibration isolator 14 in the liquid form involves. It should be noted that since the vibration isolator 15 is in the semi-cured state before the vibration isolator 15 is heated, the vibration isolator 15 does not wet and spread before being heated.

Thus, when the lift-up portion 13 is arranged on one of the base 10 and the vibration isolation target 11, the vibration isolator 15 can be placed on any one of the base 10 and the vibration isolation target 11.

The vibration isolator 15 in the semi-cured state illustrated in the present embodiment is applicable to the above-described modification examples of the first embodiment. The above-described modification examples include the followings. The lift-up portion 13 is arranged on the vibration isolation target 11. The first lift-up portion 13 and the second lift-up portion 13 are arranged on base 10 and the vibration isolation target 11, respectively.

### Third Embodiment

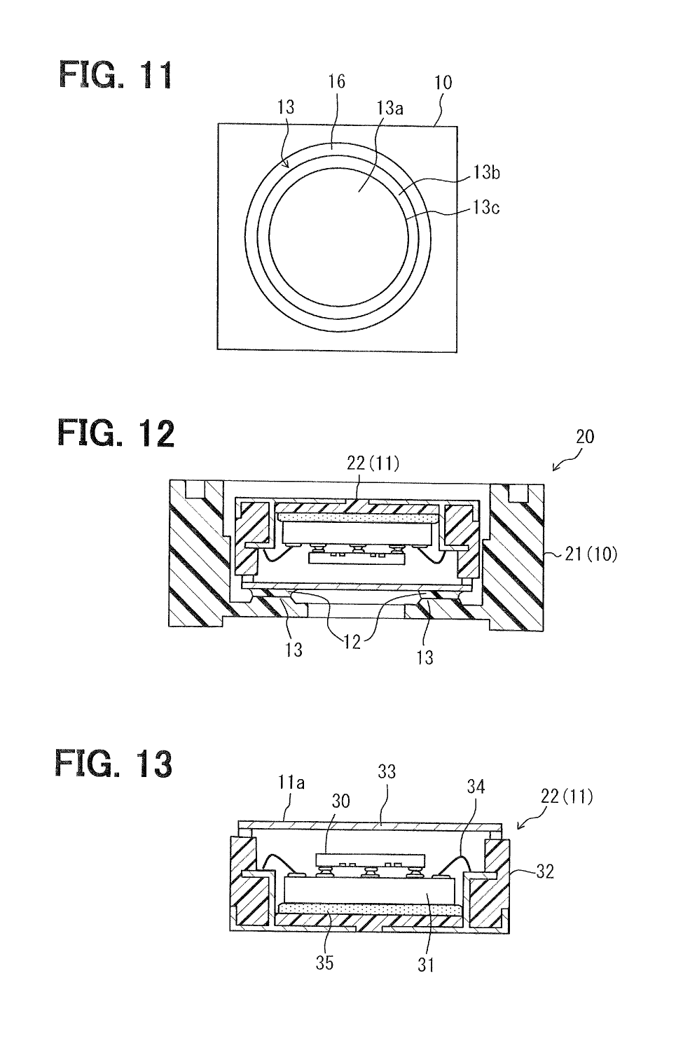

In the present embodiment, an annular groove 16 surrounding and adjoining the lift-up portion 13 is arranged. As shown in FIGS. 10 and 11, the lift-up portion 13 and the groove 16 are arranged on only the base 10 out of the base 10 and the vibration isolation target 11.

When the vibration isolation target t 12 (14, 15) is pressed by the vibration isolation target 11, the contact angle of the vibration isolation target t 12 (14, 15) with respect to the apex surface 13a of the lift-up portion 13 may exceed the predetermined contact angle θ₂, a force equilibrium may be broken. In this case, vibration isolator 12 (14, 15) in the liquid form may wet and spread into the side surface 13b.

In the present embodiment, since the groove 16 surrounds and adjoins the lift-up portion 13, even if the vibration isolator 12 (14, 15) wets and spreads into the side surface 13b, the vibration isolator 12 (14, 15) is pooled in the annular groove 16 adjoining the lift-up portion 13. Thereby, it is possible to prevent the vibration isolator 12 (14, 15) from spreading beyond the groove 16 over the one surface 10a.

In FIGS. 10 and 11, the lift-up portion 13 and the groove 16 are arranged on only the base 10. Alternatively, the lift-up portion 13 and the groove 16 may be arranged on the vibration isolation target 11. Alternatively, a first lift-up portion 13 and a first groove 16 may be arranged on the base 10, and a second lift-up portion 13 and a second groove 16 may be arranged on the vibration isolation target 11.

Next, fourth, fifth and sixth embodiments will be described. The fourth, fifth and sixth embodiments more specifically illustrates the bonding structure and the bonding method of the vibration isolation target illustrated in the first, second and third embodiments.

### Fourth Embodiment

In the present embodiment, the bonding structure and the manufacturing method illustrated in the first embodiment are applied to a sensor apparatus and a manufacturing method of the sensor apparatus. The sensor apparatus includes a sensor unit, a case and a vibration isolator. The sensor unit includes a ceramic package and a sensor chip received in the ceramic package. US 2009/0282915A corresponding to JP-2010-181392A describes a physical quantity sensor relating to the present embodiment. The disclosure of US 2009/0282915A is incorporated herein by reference.

As shown in FIG. 12, a sensor apparatus 20 includes a case 21 acting as the base 10, sensor unit 22 acting as a vibration isolation target 11, and the vibration isolator 12. The lift-up portion is provided on a bottom part of an inner surface of the case 21.

As shown in FIG. 13, the sensor unit 22 includes a sensor chip 30, a circuit chip 31, a package 32, and a lid 33.

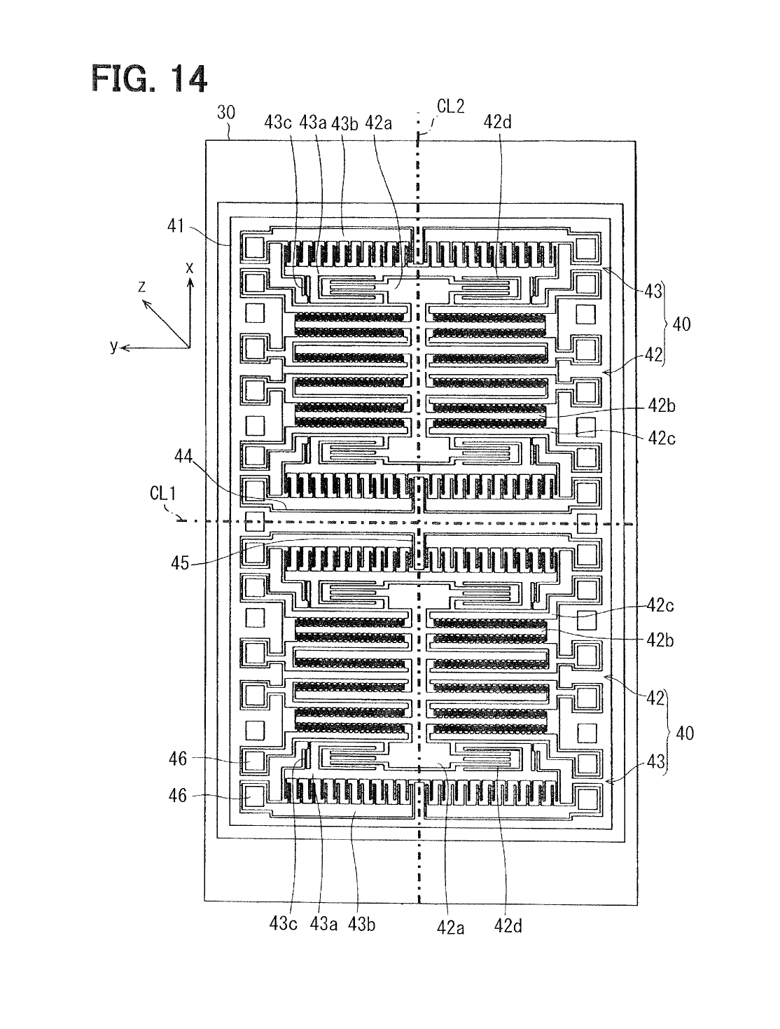

As shown in FIG. 14, the sensor chip 30 has a planer rectangular shape, and includes a pair of sensor elements 40 and a periphery part 41. The pair of sensor elements 40 have the same configuration are symmetrical with respect to a longitudinal center line CL1 extending along a short side direction of the rectangular shape. The periphery part 41 has a rectangular frame shape and supports the pair of sensor elements 40. Electric potential of the periphery part 41 is fixed to a ground electric potential. In the following, explanation will be given on one of the sensor elements 40.

The sensor element 40 includes a drive part 42 and a detection part 43. The drive part 42 includes: a weight 42a, which is supported movably with respect to the periphery part 41; multiple movable comb electrodes 42b for driving use, which are integrally connected to the weight 42a; and multiple fixed comb electrodes 42c for driving use, which are opposed to the multiple movable comb electrodes 42b and spaced apart a predetermined interval apart from the multiple movable comb electrodes 42b. The above components are arranged symmetrical with respect to a lateral center line CL2 extending the longitudinal direction of the sensor chip 30.

The detection part 43 includes: a movable electrode 43a for detection use, which is movably supported by the periphery part 41; and a fixed comb electrode 43b for detection use, which is opposed to the movable electrode 43a and is spaced t a predetermined interval apart from the movable electrode 43a. The above components are arranged symmetrical with respect to the lateral center line CL2.

The movable comb electrode 42b is movable in an x-axis direction, as shown in FIG. 14. The movable electrode 43a is movable in a y-axis direction. Note that the x-axis, the y-axis, and the z-axis are orthogonal to each other, as shown in FIG. 14. More specifically, a detection beam 43c is integrally connected to the periphery part 41. The movable electrode 43a for detection use is integrally connected to the detection beam 43c. A drive beam 42d is integrally connected to the movable electrode 43a for detection use. The weight 42a is integrally connected to the drive beam 42d. In FIG. 14, the x-axis direction is the longitudinal direction of the sensor chip 30. The y-axis direction is the shorter side direction of the sensor chip 30.

A stiffener 44 having a cross shape is arranged between the sensor elements 40. The stiffener 44 is a portion of the periphery part 41. An intersection center of the cross shape of the stiffener 44 coincides with the center of the sensor chip 30. A x-axis portion 45 of the stiffener 44 extends in the x-axis direction and is arranged between the fixed electrodes 43b. In the above, the x-axis direction is parallel to an extension direction of the weight 42a. Bonding pads 46 are arranged on the periphery part 41 and the electrodes.

In the following, an angular velocity detection operation of the sensor chip 30 will be described.

First, a periodically-varying voltage signal is applied to the fixed electrode 42c for driving use and the movable electrode 42b for driving use, causing the weight 42a to oscillate in the x-axis direction. Then, when the angular velocity around the z-axis, assumed to be a rotation axis, is applied to the sensor chip 30, the weight 42a oscillating in the x-axis direction is subjected to a Coriolis force. As a result, the weight 42a is displaced in the y-axis direction, and the detection beam 43c undergoes a deflection in the y-axis direction and the weight 42a displaces in the y-axis direction.

Displacement of the weight 42a in the y-axis direction is transmitted to the movable electrode 43a for detection use via the drive beam 42d. Since a predetermined voltage is applied between the movable electrode 43a for detection use and the fixed electrode 43b for detection use, the displacement of the movable electrode 43a changes an electrostatic capacitance between the movable electrode 43a and the fixed electrode 43b. Thus, by detecting this change in the electrostatic capacitance with a CV conversion circuit of the circuit chip 31, it is possible to detect the angular velocity of the sensor chip 30.

Each of the fixed electrode 43b for detection use and the movable electrode 43a for detection use is elongated parallel to at least one of sides of the sensor chip in a planer direction of the sensor chip 30. That is, the change in the electrostatic capacitance between the fixed electrode 43b and the movable electrode 43a is caused by the displacement of the movable electrode 43a in the direction of the at least one of the sides of the sensor chip.

In order to reduce an influence of outside-originating vibration-noise, the weights 42a of the two sensor elements 40 may oscillate in opposite directions along the x-axis. Specifically, when one of the sensor elements 40 is displaced in a plus direction of the x-axis, the other of the sensor elements 40 is displaced in a minus direction of the x-axis. In response to application of the angular velocity, one of the weights 42a is displaced in a plus direction of the y-axis and the other of the weights 42a is displaced in a minus direction of the y-axis.

The sensor element 40 shown in FIG. 14 has so called an external-detection and internal-driving structure in which the detection part 43 is connected to and supported by the periphery part 41, and the drive part 42 is supported by the periphery part 41 via the detection part 43. Alternatively, the sensor element 40 may have so called an external-driving and internal-detection structure in which the drive part 42 is connected to and supported by the peripheral part 41 and the detection part 43 is supported by the periphery part 41 via the drive part 42.

The circuit chip 31 includes a circuit for processing an electric signal indicating a change in electrostatic capacitance or a voltage detected with the sensor chip 30, and for adjusting the voltage to be applied to the sensor chip 30. The sensor chip 30 and the circuit chip 31 are formed on, for example, a silicon substrate or a ceramic substrate. In an example shown in FIG. 14, a target for detection by the sensor chip 30 is angular velocity. However, the detection target of the present embodiment is not limited to angular velocity. For example, the detection target may be, for example, acceleration in the x-axis direction or the y-axis direction. A function of the circuit chip 31 or the like may be changed on an as-needed basis according to application of the sensor apparatus 20.

The sensor chip 30 and the circuit chip 31 are electrically connected to each other by a bonding wire 34. The sensor chip 30 and the circuit chip 31 may be integrally formed on a same silicon substrate.

The package 32 is made of ceramics or resin, and has a box shape with an opening on one surface. The package 32 and the lid 33 form therebetween a space for receiving the sensor chip 30 and the circuit chip 31. An adhesive 35 bonds the circuit chip 31 and the package 32 together. In order to relax a thermal stress acting on the circuit chip 31, it may be preferable to adopt a soft adhesive having a small elastic module as the adhesive 35 for bonding the circuit chip 31 and the package 32 together. The sensor chip 30 and the circuit chip 31 are electrically connected to each other in such way that corresponding pads are electrically connected to each other by solder bumps or the like. In this way, the circuit chip 31 and the sensor chip 30 are mounted to the package 32 in this order. An outer surface of the lid 33 fixed to an open end of the package 32 acts as the one surface 11a, which is opposed to the case 21 acting as base 10.

The above sensor unit 22 is received in the case 21, as shown in FIG. 12. The case 21 is a resin molded body and is formed into a rectangular tubular shape. Multiple leads 50 for electrically connecting an inside of the case 21 to an outside of the case 21 are inserted into the case 21.

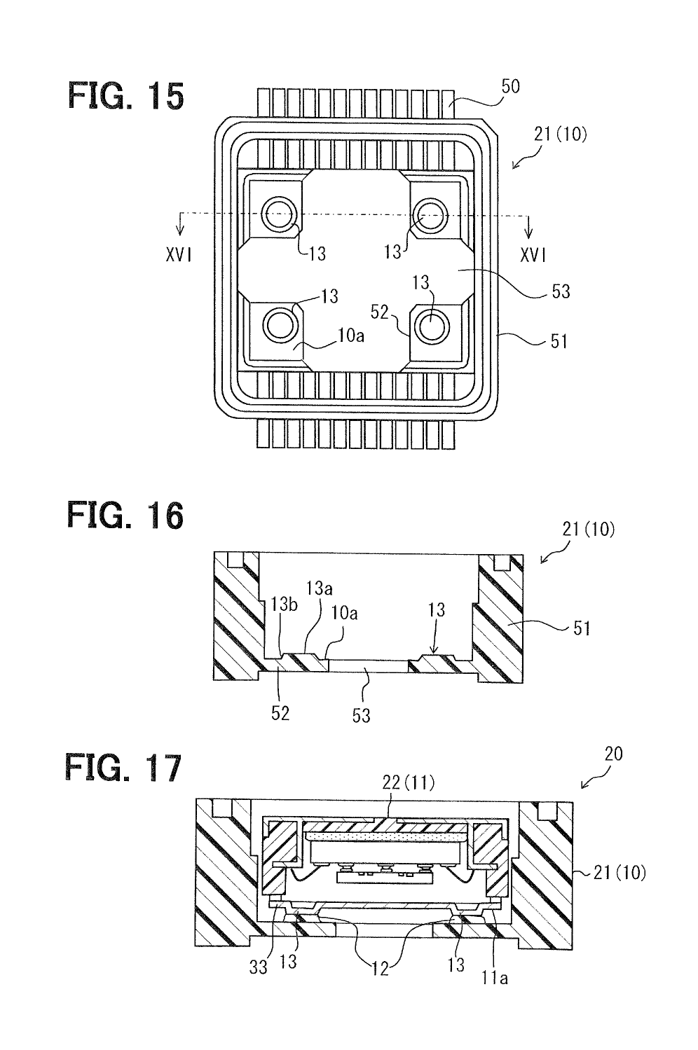

The case 21 has a side wall 51 and a bottom part 52, as shown in FIGS. 15 and 16. The side wall 51 is a rectangular tubular body surrounding an outer periphery of the sensor unit 22. The bottom part 52 is projected from an end portion of the side wall 51 into an inside of the side wall 51. An inner surface of the bottom part 52 opposed to the lid 33 of the sensor unit 22 acts as the one surface 10a of the base 10. As shown in FIG. 15, the bottom part 52 has a cross-shaped opening 53. The opening 53 penetrates the bottom part 52 from the one surface 10a to a rear surface opposite to the one surface 10a. The opening 53 divides the bottom part 52 into four regions, which respectively correspond to corners of the side wall 51. The side wall 51 is rectangular in cross section along an x-y plane.

The lift-up portion 13 lift-upped from the one surface 11a is integrated with the bottom part 52 of the case 21. In the present embodiment, four lift-up portions 13 are arranged on the divided four regions of the bottom part 52, respectively. The angle α between the apex surface 13a and the side surface 13b is in an range between 200 degrees to 250 degrees, and may be approximately 230 degrees, as described in the first embodiment (see FIG. 1). The shape of the apex surface 13a is a true circle, as shown in FIG. 15.

The vibration isolator 12 is arranged between the one surface 11a of the lid 33 of the sensor unit 22 and the apex surface 13a of the lift-up portion 13 of the bottom part 52, as shown in FIG. 12. The vibration isolator 12 connects and bonds the case 21 and the sensor unit 22 together. Thereby, the sensor unit 22 is held to the bottom part 52 of the case 21 by the vibration isolator 12. A curable elastomer can be used as a material of the vibration isolator 12. It may be preferable to use a heat-resistant and environmentally-resistant material such as silicon rubber, fluoro-rubber, silicon-modified epoxy resin and the like.

The above structure for bonding the sensor unit 22 to the case 21 can be formed through the following steps. A liquid form elastomer, which constitutes the vibration isolator 12 and corresponding to the vibration isolator in the liquid form of the first embodiment, is applied to the apex surface 13a of the lift-up portion 13 of the bottom part 52 of the case 21 integrated with the lead 50. The sensor unit 22 on the case 21 are positioned and placed so that the applied elastomer contacts with the one surface 11a of the lid 33. The elastomer is cured by heat to change the elastomer into the vibration isolator 12, and bond the case 21 and the sensor unit 22 together.

In the present embodiment, the sensor apparatus 20 is configured such that: the lift-up portion 13 is arranged on the case 21 acting as the base 10; the vibration isolator 12, which has cured by heat, is arranged between the apex surface 13a of the lift-up portion 13 of the case 21 and the sensor unit 22 (specifically, one surface 11a of the lid 33) acting as the vibration isolation target 11. Therefore, the present embodiment has the substantially same advantages as the first embodiment has. For example, the vibration of a frequency having a negative influence on the angular velocity detection can be efficiently suppressed.

In the present embodiment, the case 21 has the opening 53. Thus, when the sensor unit 22 (specifically, the pad of the package 32) and the lead 50 mounted to the case 21 are connected to each other by a bonding wire (not shown) after the vibration isolator 12 is cured, it is possible to insert a jig (not shown) in the opening 53 and it is possible to conduct wire-bonding while supporting the sensor unit 22 with the jig. Therefore, while the vibration isolator 12 made of elastomer is employed, a change in position of the sensor unit 22 in an upper/lower direction at the time of wire-bonding can be reduced. It is possible to reliably connect the bonding wire to the pad of the sensor unit 22.

In the present embodiment, the elastomer in the liquid form is used as the vibration isolator 12. Alternatively, it is possible to use the vibration isolator 15 in the semi-cured state (e.g., the elastomer in the semi-cured state) illustrated in the second embodiment. This alternative configuration has the substantially same advantages as the second embodiment has.

### Fifth Embodiment

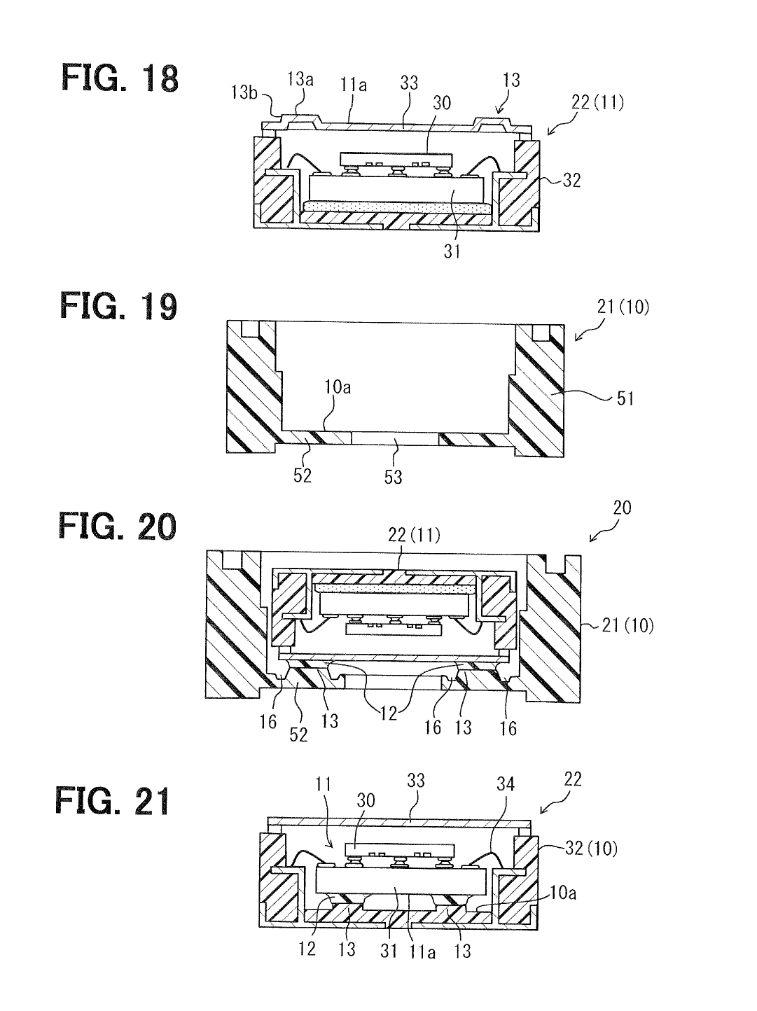

As shown in FIGS. 17 to 19, the present embodiment is different from the fourth embodiment in that in the present embodiment, the lift-up portion 13 is arranged not on the case 21 acting as the base 10 but on the sensor unit 22 acting as the vibration isolation target. The present embodiment and the fourth embodiment are the substantially except the arrangement of the lift-up portion 13.

Specifically, the lid 33 constituting the sensor unit 22 is made of a metal material (e.g., iron-nickel-cobalt alloy, iron-nickel alloy). By press working, the lift-up portion 13 is lift-upped from the one surface 11a and is integrated with the lid 33. In the present embodiment, the four lift-up portions 13 are arranged at four places on the lid 33 like the lift-up portions 13 of the case 21 illustrated in the fourth embodiment. The apex surface 13a of each lift-up portion 13 is a true circular shape.

This sensor apparatus 20 also can achieve the substantially same advantages as described in the first embodiment. For example, the vibration of a frequency having a negative influence on the angular velocity detection can be efficiently suppressed.

In the present embodiment also, it is possible to use the vibration isolator 15 in the semi-cured state (e.g., the elastomer in the semi-cured state) as illustrated in the second embodiment. In this case, it is possible to achieve the substantially same advantages as described in the second embodiment.

The lift-up portion 13 may be arranged on each of the case 21 and the sensor unit 22 (specifically, the lid 33).

### Sixth Embodiment

As shown in FIG. 20, in the present embodiment, the annular groove 16 adjoining the lift-up portion 13 are arranged. The present embodiment and the fourth embodiment are the substantially same except the annular groove 16.

Specifically, the lift-up portion 13 is arranged on the inner surface of the bottom part 52 of the case 21, which acts as the one surface 11a of the base 10. The groove 16 is arranged on the inner surface of the bottom part 52 so as to adjoin and surround the lift-up portion 13. The groove 16 is a portion of the case 21 and formed when the case 21 is formed by injection molding.

Since the sensor apparatus 20 of the present embodiment has the lift-up portion 13 and the groove 16, the present embodiments achieves the substantially same advantages as the third embodiment.

In FIG. 20, the lift-up portion 13 and the groove 16 are arrange don the case 21. Alternatively, the lift-up portion 13 and the groove 16 may be arranged on the sensor unit 22 (specifically, the lift 33). Alternatively, the first lift-up portion 13 and the first groove 16 may be arrange don the case 21, and the second lift-up portion 13 and the second groove 16 may be arranged on the sensor unit 22 (specifically, the lift 33).

### Other Embodiments

Embodiments are not limited to the above-described embodiments. Examples of other embodiments will be described.

In the above embodiments, the apex surface 13a of the lift-up portion 13 is a flat surface (i.e., planer). Alternatively, the apex surface 13a of the lift-up portion 13 may be a surface having undergone a roughening process such as grain finish, surface texturing and the like. In this alternative case, it is possible to improve reliability of a connection and an adhesiveness between the vibration isolator 12 and the apex surface 13a.

In the above embodiment, the sensor chip 30 acting as the vibration isolation target 11 includes a detector (i.e., sensor element 40) for detecting angular velocity. However, the detector sensitive to an external vibration is not limited to one for detecting angular velocity. Alternatively, the detector sensitive to an external vibration may be other detectors which have a detection error due to conduction of the external vibration thereto. For example, the detector sensitive to an external vibration may be a detector for detecting physical quantity such as acceleration, pressure and the like.

In the fourth, fifth and sixth embodiments, the case 21 corresponds to the base 10, and the sensor unit 22 corresponds to the vibration isolation target. Alternatively, as shown in FIG. 21, the packages 32 constituting the sensor unit 22 may correspond to the base 10, and the sensor chip 30 and the circuit chip 31 received in the package 32 and the lid 33 may correspond to the vibration isolation target 11. In FIG. 21, an inner surface of a bottom portion of the package 32 corresponds to the one surface 10a of the base 10, on which the lift-up portion 13 is provided. Furthermore, the vibration isolator 12 is employed in place of the adhesive 35, and the vibration isolator 12 bonds the circuit chip 31 and the package 32 together.

While the invention has been described above with reference to various embodiments thereof, it is to be understood that the invention is not limited to the above described embodiments and constructions. The invention is intended to cover various modifications and equivalent arrangements.

What is claimed is:

1. A bonding structure comprising:
a base;
a vibration isolation target that is mounted to the base and is a target for vibration isolation; and
a vibration isolator that is arranged between and bonds together the base and the vibration isolation target, and damps a relative vibration between the base and the vibration isolation target,
wherein:
the base and the vibration isolation target have, respectively, a first opposed surface and a second opposed surface that are opposed to each other;
a lift-up portion is formed on at least one of the first opposed surface and the second opposed surface, and is lift-upped from the one toward the other of the first opposed surface and the second opposed surface;
the lift-up portion has
an apex surface located at an apex of the lift-up portion,
a side surface surrounding the apex surface, and
a corner formed by the apex surface and the side surface so that the corner surrounds the apex surface; and
the vibration isolator bonds
only the apex surface, out of one of the first opposed surface and the second opposed surface,
to the other of the first opposed surface and the second opposed surface.

2. The bonding structure according to claim 1, wherein:
the lift-up portion is formed as a first lift-up portion on the first opposed surface of the base and a second lift-up portion on the second opposed surface of the vibration isolation target; and
the apex surface of the first lift-up portion and the apex surface of the second lift-up portion have a same shape and a same size, and are arranged opposed each other.

3. The bonding structure according to claim 1, wherein:
shape of the apex surface is a true circle.

4. The bonding structure according to claim 1, wherein:
the vibration isolation target includes a sensor chip having a detection part for detecting physical quantity.

5. The bonding structure according to claim 4, wherein:
the detection part has an oscillator to detect angular velocity.

6. The bonding structure according to claim 4, wherein:
the vibration isolation target further includes
a package that has a box shape, has an opening on one surface of the package, and receives therein the sensor chip, and
a lid that covers the opening; and
the base is a case for receiving the vibration isolation target.

7. The bonding structure according to claim 6, wherein:
the case is a resin molded body; and
the lift-up portion is integrated with the case.

8. The bonding structure according to claim 6, wherein:
the lid is made of metal; and
the lift-up portion is integrated with the lid.

9. The bonding structure according to claim 1, wherein:
one of the base and the vibration isolation target, the one having the lift-up portion, has an annular groove that adjoins and surrounds the lift-up portion.

10. The bonding structure according to claim 1, wherein:
the vibration isolator is made of elastomer.

11. A method for forming a bonding structure of claim 1, the method comprising:
placing the vibration isolator in a liquid form or in a semi-cured state on one of the base and the vibration isolation target so that the vibration isolator is placed on the apex surface of the lift-up portion or a opposed portion that is opposed to the apex surface;
positioning and placing the other of the base and the vibration isolation target relative to the one, on which the vibration isolator is placed, of the base and the vibration isolation target, so that the apex surface of the lift-up portion or the opposed portion contacts the vibration isolator; and
curing the vibration isolator after positioning and placing the other of the base and the vibration isolation target.

12. The method according to claim 11, wherein:
placing the vibration isolator includes
placing the vibration isolator on the apex surface of the lift-up portion of the one of the base and the vibration isolation target.
